(19) United States
(12) Patent Application Publication
(10) Pub. No.: US 2014/0190965 A1
(43) Pub. Date: Jul. 10, 2014

(54) PRESSURE VESSEL

(71) Applicants: Peter Kloft, Ransbach-Baumbach (DE); Herbert Baltes, Losheim (DE)

(72) Inventors: Peter Kloft, Ransbach-Baumbach (DE); Herbert Baltes, Losheim (DE)

(21) Appl. No.: 13/261,790

(22) PCT Filed: Aug. 1, 2012
(86) PCT No.: PCT/EP2012/003264

§ 371 Date: Dec. 11, 2013

(30) Foreign Application Priority Data
Aug. 19, 2011 (DE) 10 2011 111 098.8

(51) Int. Cl. F15B 1/16

(52) U.S. Cl. CPC F15B 1/16
USPC 220/4.12

(57) ABSTRACT

A pressure vessel which is provided preferably for use in bladder accumulators (27), having a multi-part vessel body (1) composed of a tubular central part (3) which, at at least one of its two ends, has a termination region (5, 7), is characterized in that a cover part (9) which at least partially forms the respective termination region (5, 7) engages at the edge over the central part (3), at least in the region of the respectively assignable end (13, 15) thereof, so as to form a fixed connection.

The invention relates to a pressure vessel, preferably provided for use in bladder accumulators having a multipart vessel body, consisting of a tubular central part having a termination region on at least one of its ends. Furthermore, the invention relates to a bladder accumulator having such a multipart vessel body.

There are state-of-the-art pressure accumulators having multipart vessel bodies for storage of liquid and/or gaseous media under pressure. For example, WO 2007/085276 A1 discloses a pressure vessel in which the multipart vessel body is constructed of a first plastic shell and a second plastic shell encompassing the first plastic shell. The first plastic shell forming the vessel core is preferably made of polyamide and is obtained by means of a blow molding process. The first shell is reinforced on the outer circumference by a fiber wrapping as a second plastic shell wound onto it from the outside. The reinforced winding consists of a fiber reinforcement such as carbon fibers, aramit fibers, glass fibers, drilling fibers, Al₂O₃ fibers or mixtures thereof, wherein the fiber reinforcement is embedded in a basic matrix of thermosetting plastics, for example, epoxy resins or phenolic resins or in thermoplastics, for example, in the form of PA12, PA6, PP, etc.

Such pressure vessels made of plastic are characterized by a low structural weight and an extensive insensitivity to negative effects due to corrosive media with which they are in contact on the inside and/or outside, but these advantages require a corresponding manufacturing complexity.

Against the background of this prior art, the object of the invention is to make available a pressure vessel which can be manufactured comparatively more easily and more economically while retaining the aforementioned advantages.

According to the invention, this object is achieved by a pressure vessel having the features of claim 1 in its entirety.

An essential particular feature of the invention consists of the fact that a cover part, forming at least partially the respective end region, extends beyond the central part, at least in the region of its respectively allocable end, while forming a fixed joint at the edges. This opens up the advantageous possibility of designing a pressure-tight vessel in a lightweight design, in which multiple different plastic shells need no longer be arranged one above the other as in the prior art, but instead it is sufficient to manufacture the termination region of a central part of the pressure vessel that is of interest by closing same by means of the cover part shown. In addition to a simple structural design, which can be manufactured economically and inexpensively to this extent, the approach according to the pressure vessel according to the invention, with regard to maintaining pressure strength values, has no disadvantages in comparison with the complex approaches in the prior art.

In a preferred embodiment of the pressure vessel according to the invention, it is provided that a cap be provided as an additional component of the respective termination region, this cap being connected to the respective pipe end of the central part to be allocated thereto, wherein the cover part is designed in the manner of a cover laminate, which extends at least partially beyond the respective cap. To this extent, there is the possibility of providing the tubular central part with an end cap in addition to the cover laminate in the region of its two free ends, so that to this extent one obtains better sealing results and greater strength values than if this were the case if the free ends of the central part were to be terminated directly with the cover parts to be shaped like a hollow cap, but omitting the caps directly.

It is preferably provided in particular that the tubular central part, like the respectively cap is to be made of a fiber composite material and/or from a laminate of fibers, preferably a glass fiber-reinforced plastic material (GRP). Additional materials that may be used include aramid fibers, carbon fibers or combinations of these materials. Thus preferably standard tubes made of GRP for the central part may be used such as those manufactured in large quantities by the wrapping process for conventional plant manufacturing and freely obtainable on the market. Such pipes are obtained inexpensively, with and without a chemical-resistant layer, thereby permitting an adaptation of the pressure vessel according to the invention to the respective fields of application, even for applications involving particularly aggressive chemical media. Such pipes are constructed of glass fiber-reinforced vinyl ester resin, for example, and the caps for the end of the central part are preferably manufactured by manual lamination methods and may be constructed of comparable plastic materials as well as the respective cover laminate, which terminates the composite of the cap and central part with a seal to the outside.

In a particularly preferred embodiment, the pressure vessel according to the invention is characterized in that the respective cap is designed in the form of a hemisphere having at least one opening uncovered by the cover laminate for introducing a corresponding pressure medium. The design of the respective cap as a hemisphere has proven favorable for the introduction of pressures and pressure peaks into the vessel material of the pressure vessel. The pressure vessel need not be constructed entirely of plastic materials. There is always the possibility of also forming the central part of a cast metal material and forming one of the end caps as the termination region of the vessel which is then to be connected in a pressure-tight manner to the central part by a conventional welding method, accordingly. On the other hand, the other end of the central part can then be sealed, accordingly, with the termination region designed according to the invention using a plastic cover laminate and/or a plastic cap. A lightweight design of the pressure vessel as a whole can then also be achieved to this extent.

To be able to make pressure vessels designed in this way available for the widest possible range of applications, a modular design of the pressure vessel with its components is preferably provided, which also includes constructing the central part from individual pipe parts, optionally subdivided into multiple segments, the pipe segments of the central part, for example, being fixedly connectable to one another by adhesive joints.

The arrangement may advantageously be such that the caps are glued to the respective pipe ends, for example, by means of a multicomponent adhesive and then permanently joined to the pipe by means of the cover laminate.

Such a design is also characterized by a secure operating behavior because the failure of such components is to be classified as fortunate, because so-called “weeping” occurs at an excessive internal pressure, in which the vessel simply becomes leaky like a porous tube. This is based on the effect that, in an overload, multiple resin fractures always occur in the laminate (interfiber fractures), which ultimately lead to leaking, with a corresponding reduction in the overload without resulting in any threat to the environment.

The cover laminate preferably extends beyond the connecting site between the cap and the pipe end over a region of the adjacent pipe beyond the central part to thereby achieve a secure attachment of the cover laminate to the central part. To be able to absorb high compressive forces in the interior of the pressure vessel accordingly, it is provided that the cover laminate, which can be manufactured particularly preferably by the manual lamination method on the actual vessel housing, is preferably designed to be thicker and/or more compact in the direction of the uncovered opening for the passage of the respective pressure medium from the application of material.

In a particularly preferred embodiment of the pressure vessel according to the invention, it is also possible to provide that the central part is to be covered completely by means of two opposing cover laminates by joining the two neighboring ends of the two cover laminates to one another in a pressure-tight manner. In such a case, the central part consisting of a plastic material becomes a type of liner, so that the vessel body according to the invention can readily be used even in the high pressure range (>25 bar).

However, the vessel bodies according to the invention are pressure-tight, at least in the low pressure range (<25 bar), without an additional lining in the form of a liner, regardless of the specific design. As an alternative to the vessel approach described above, forming a liner, it is also possible to provide that the inner chamber of the vessel body is furnished with a liner, preferably in the form of a plastic coating, as a liner applied in the form of a centrifugal sintering or rotational sintering method.

In addition to the resulting higher compressive strength, such a liner may also serve as a chemical-resistant layer. For a particularly high compressive strength, the cover laminate could also extend over the entire pipe length of the central part.

To form a bladder accumulator, both caps may have an opening, one of which is connected to the inner chamber of a accumulator bladder.

According to claim 10, the subject matter of the invention is also a bladder accumulator which has a pressure vessel according to the invention and is provided for media separation, in particular the separation of water/glycol mixtures from sea water in marine facilities.

The invention is explained in detail below with reference to the drawings.

They show:

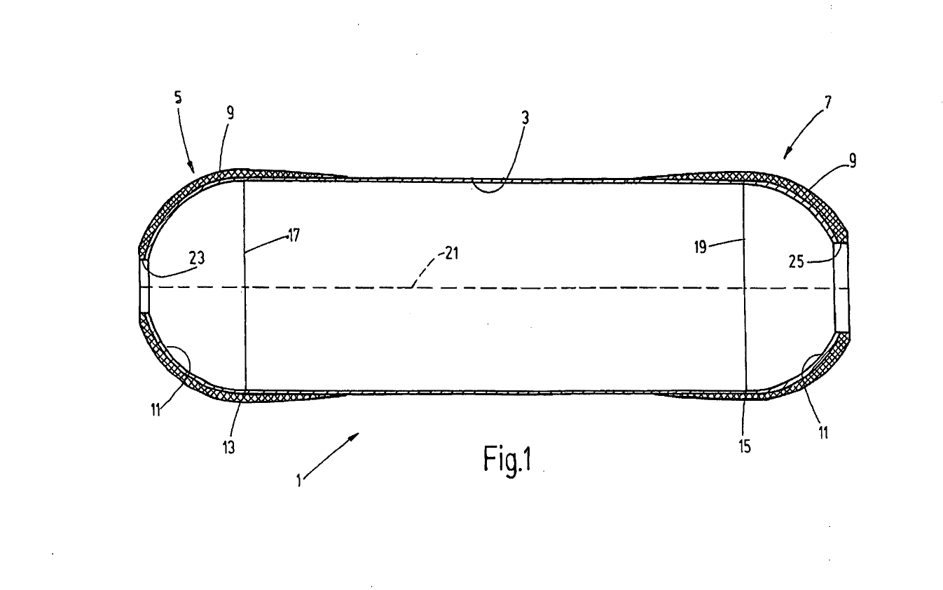

FIG. 1 the essential parts of an exemplary embodiment of the pressure vessel according to the invention, shown in a longitudinal section in a schematic diagram not drawn to scale,

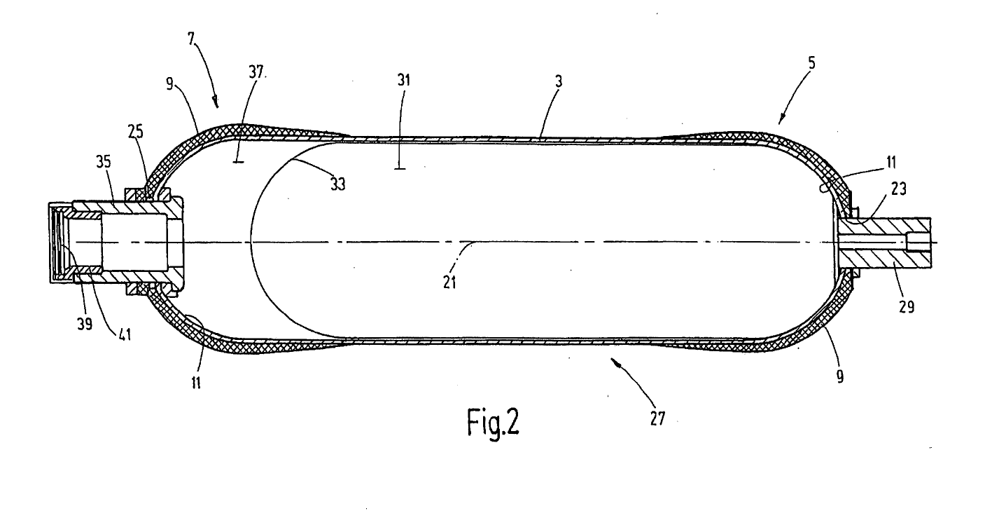

FIG. 2 a bladder accumulator having the pressure vessel of FIG. 1 in a longitudinal section like that in FIG. 1, and

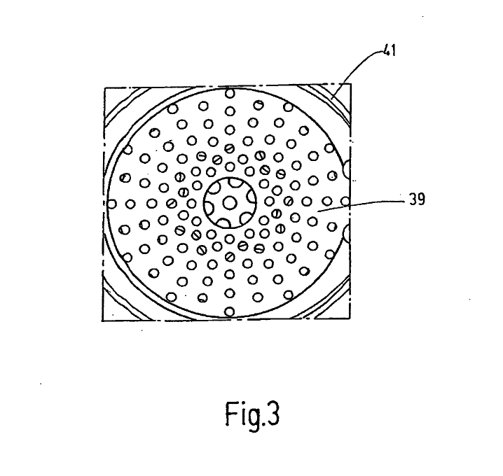

FIG. 3 a partial top view of the sea water connecting part of the bladder accumulator of FIG. 2, shown in an enlarged scale.

In the exemplary embodiments illustrated here, the vessel body 1 of the pressure vessel is constructed of three main parts, namely a central part in the form of a cylindrical pipe 3, and termination regions 5 and 7 connected to the ends of the pipe 3 forming the central part. The pipe 3 forming the central part is a GRP pipe manufactured by the wrapping method from glass fiber-reinforced vinyl ester resin, for example. Termination regions 5 and 7 have a cover laminate 9 of synthetic resins and reinforcing material surrounding the outside of one cap each, which is connected to the pipe ends 13 and 15, in the exemplary embodiment shown here. The caps 11 are in the form of hemispheres produced in a mold by the manual lamination method. The caps 11 are glued to the pipe ends 13 and 15 by means of a multicomponent adhesive. As shown in the drawing, the cover laminate 9 is applied in such a way that it extends over the respective connecting line 17 and 19 to the pipe ends 13 and/or 15 over a length preferably approximately one-third to one-fourth of the pipe 3 forming the central part. For a vessel body 1 of a high compressive strength, the cover laminate 9 could be applied over the full length of the pipe 3.

In the example shown here, the central part 3 is formed from a one-piece pipe 3. It is self-evident that more than one pipe may form the central part, wherein the cover laminate 9 may optionally run over additional connecting lines.

In the example in FIG. 1, media openings 23 and 25, which are concentric to the cylinder axis 21 and are free of the cover laminate 9 are provided on both end caps 11, wherein the opening 25 adjacent to the pipe end 15 has a larger diameter than the other opening 23.

FIG. 2 shows in a schematically simplified diagram a bladder accumulator having a vessel body 1 according to the exemplary embodiment shown in FIG. 1. As this shows, a connecting part 29, which forms a fluid connection to the inner chamber 31 of a conventional accumulator bladder 33, is situated on the opening 23 having the smaller diameter. A connecting part 35, which forms the fluid connection to the chamber 37 on the outside of the accumulator bladder 33, is situated on the other opening. 25 having the larger diameter. In a preferred application, the accumulator bladder 33 may form a movable separation element for media separation, for example, separating sea water in the chamber 37 from a water/glycol mixture in the inner chamber 31 of the accumulator bladder 33 when the bladder accumulator 27 is used in maritime facilities.

The exemplary embodiment of a bladder accumulator 27 provided with the pressure vessel according to the invention, as shown in FIG. 2, the bladder accumulator being provided for maritime use has a sea water screen 39 on the connecting part 35, which forms the sea water access. This is situated in a threaded insert 41 that can be screwed into the connecting part 35. FIG. 3 shows a detail of the threaded insert 41 with a view of the hole pattern of the sea water screen 39. The screen 39 is preferably made of an anodic material such as copper, which functions as an electrolyte in combination with the sea water, so that the screen 39 prevents not only the admission of living creatures or soiling to the chamber 37 of the bladder accumulator 27 but also forms protection against microorganisms.

1. A pressure vessel preferably provided for use with bladder accumulators (27), having a multipart vessel body (1) consisting of a tubular central part (3), which has a termination region (5, 7) on at least one of its two ends, characterized in that a cover part (9), which forms at least partially the respective termination region (5, 7), extends beyond the central part (3) at least in the region of its respective end (13, 15) while entering into a fixed connection.

2. The pressure vessel according to claim 1, characterized in that a cap (11) which is connected to the respective pipe end (13, 15) of the central part (3) is provided as an additional component of the respective termination region (5, 7) and the cover part (9) is designed in the manner of a cover laminate, which extends at least partially beyond the respective cap (11).

3. The pressure vessel according to claim 1, characterized in that the tubular central part (3), like the respective cap (11), is made of a fiber composite material and/or a laminate of fibers.

4. The pressure vessel according to claim 1, characterized in that the respective cap (11) is designed in the form of a hemisphere having at least one opening (23, 25) which is left uncovered by the cover laminate (5), for introducing a corresponding pressure medium.

5. The pressure vessel according to claim 1, characterized in that the caps (11) are adhesively bonded to the respective pipe end (13, 15), preferably by means of multicomponent adhesive.

6. The pressure vessel according to claim 1, characterized in that the respective cover laminate (9) extends beyond the connecting location (17, 19) between the cap (11) and the pipe end (13, 15), at least over a region of the adjacent tubular central part or completely covers the central part (3), in that the two adjacent ends of two opposing cover laminates (9) are joined together in a pressure-tight manner.

7. The pressure vessel according to claim 1, characterized in that its inner chamber (37) is provided with a lining, preferably in the form of a plastic liner, applied by a centrifugal sintering or rotational sintering method.

8. The pressure vessel according to claim 1, characterized in that, to form a bladder accumulator (27), both caps (11) have an opening (23, 25), one (23) of which is connected to the inner chamber (31) of an accumulator bladder (33).

9. The pressure vessel according to claim 1, characterized in that a sea water screen (39) is provided on an opening (25) of a cap (11) provided for admission of sea water.

10. A bladder accumulator (27) which has a pressure body (1) according to claim 1 and is provided for media separation, in particular for the separation of water/glycol mixtures from sea water in maritime facilities.
